(19) United States
(12) Patent Application Publication
(10) Pub. No.: US 2026/0088435 A1
(43) Pub. Date: Mar. 26, 2026

(54) BARRIER, AND BATTERY ASSEMBLY INCLUDING THE SAME

(71) Applicant: SK On Co., Ltd., Seoul (KR)

(72) Inventor: Dong Jun LIM, Daejeon (KR)

(21) Appl. No.: 19/333,284

(22) Filed: Sep. 18, 2025

(30) Foreign Application Priority Data
Sep. 20, 2024 (KR) 10-2024-0127183

(51) Int. Cl. H01M 50/291; H01M 10/658; H01M 50/105; H01M 50/211; H01M 50/293

(52) U.S. Cl. CPC H01M 50/291; H01M 10/658; H01M 50/105; H01M 50/211; H01M 50/293

(57) ABSTRACT

The present disclosure relates to a barrier and a battery assembly including the same. According to one embodiment, the barrier is a barrier disposed between at least one pair of adjacent battery cells among a plurality of stacked battery cells, and comprises: a base portion having a sheet shape; a first cover portion and a second cover portion respectively extending from at least one side of the base portion; wherein an extension length of the first cover portion may be shorter than an extension length of the second cover portion.

### CROSS-REFERENCE TO RELATED PATENT APPLICATION

The present application claims priority under 35 U.S.C. § 119(a) to Korean patent application number 10-2024-0127183 filed on Sep. 20, 2024, in the Korean Intellectual Property Office, the entire disclosure of which is incorporated by reference herein.

### BACKGROUND OF THE INVENTION

### 1. Field

The present disclosure relates to a barrier and a battery assembly including the same. More specifically, the present disclosure relates to a barrier having an improved effect of blocking and suppressing the propagation of heat or flame in the event of a thermal runaway, and a battery assembly including the same.

### 2. Description of the Related Art

A secondary battery is a battery configured to convert electrical energy into chemical energy for storage, and to be reused multiple times through charging and discharging. In order to obtain desired output and performance, a plurality of secondary batteries may be grouped and manufactured as a battery assembly. Such a battery assembly may include a plurality of secondary batteries, that is, a plurality of battery cells, in an internal receiving space as described above.

When a thermal runaway event occurs in any one of the plurality of battery cells accommodated in the battery assembly, the heat or flame generated from the corresponding cell may be easily propagated to an adjacent cell. In such a case, due to the characteristics of the secondary battery, a serious safety problem may be caused.

Meanwhile, even when heat or flame is generated in a specific region of the battery assembly due to a thermal runaway event, the heat or flame may rapidly propagate to another region due to a convection effect, even if the propagation path is relatively narrow.

### SUMMARY OF THE INVENTION

According to one aspect of the present disclosure, a barrier having an improved effect of blocking and suppressing the propagation of heat or flame in the event of a thermal runaway may be provided.

According to another aspect of the present disclosure, a barrier capable of protecting a battery cell in multiple directions from heat or flame generated during a thermal runaway event may be provided when inserted between battery cells.

According to still another aspect of the present disclosure, a battery assembly with improved safety may be provided without a separate design change by including the above-described barrier.

Meanwhile, the present disclosure may be widely applied in the fields of green technology, including electric vehicles (EVs), battery charging stations, energy storage systems (ESS), photovoltaics, and wind power, all of which utilize batteries. In addition, the present disclosure may be used in eco-friendly mobility, including electric vehicles and hybrid vehicles, to prevent climate change by reducing air pollution and greenhouse gas emissions.

According to the present disclosure, a barrier is a barrier disposed between at least one pair of adjacent battery cells among a plurality of stacked battery cells, and the barrier comprises: a base portion having a sheet shape; a first cover portion and a second cover portion respectively extending from at least one side of the base portion; wherein an extension length of the first cover portion may be shorter than an extension length of the second cover portion.

In one embodiment of the barrier, the base portion, the first cover portion, and the second cover portion may each independently comprise at least one of a fiber or an inorganic material.

In one embodiment of the barrier, a thickness of the first cover portion may be greater than a thickness of the second cover portion.

In one embodiment of the barrier, an extension length of the first cover portion may be 0.4 to 0.6 times an extension length of the second cover portion.

In one embodiment of the barrier, the base portion may comprise a reinforcement member.

In one embodiment of the barrier, the barrier may suppress propagation of heat or flame.

According to the present disclosure, a battery assembly comprises: a plurality of battery cells stacked in a first direction; a barrier disposed between at least one pair of adjacent battery cells among the plurality of battery cells; and a receiving case configured to accommodate the plurality of battery cells and the barrier, wherein the barrier may comprise: a base portion having a sheet shape; and a first cover portion and a second cover portion extending in the first direction from at least one side of the base portion.

In one embodiment of the battery assembly, each of the plurality of battery cells may comprise: an electrode assembly; an electrode terminal electrically connected to the electrode assembly and protruding in a second direction intersecting the first direction; and a cell case configured to accommodate the electrode assembly therein and comprising a first sub-surface and a second sub-surface configured to cover the electrode assembly in a third direction intersecting both the first direction and the second direction, wherein a folding portion may be formed on at least a part of the first sub-surface. The barrier may be disposed such that the base portion covers the battery cell in the first direction, the first cover portion covers at least a part of the first sub-surface, and the second cover portion covers at least a part of the second sub-surface.

In one embodiment of the battery assembly, the first cover portion and the second cover portion may have a sheet shape.

In one embodiment of the battery assembly, the base portion may be connected to respective central portions of the first cover portion and the second cover portion.

In one embodiment of the battery assembly, the base portion, the first cover portion, and the second cover portion may each independently comprise at least one of a fiber or an inorganic material.

In one embodiment of the battery assembly, a thickness of the base portion may be 1 mm to 5 mm.

In one embodiment of the battery assembly, a thickness of the first cover portion may be greater than a thickness of the second cover portion.

In one embodiment of the battery assembly, an extension length of the first cover portion may be shorter than an extension length of the second cover portion.

In one embodiment of the battery assembly, an extension length of the first cover portion may be 0.4 to 0.6 times an extension length of the second cover portion.

In one embodiment of the battery assembly, the battery assembly may satisfy a relation defined by the following Equation 1:

$$0.8 \leq \frac{{L}_{1} - {W}_{b}}{{W}_{c}} \leq 1.1 \qquad [ Equation 1 ]$$

where L₁ is an extension length of the first cover portion, W_{b} is a thickness of the base portion, and W_{c} is a thickness of the battery cell.

In one embodiment of the battery assembly, the battery assembly may satisfy a relation defined by the following Equation 2:

$$1.8 \leq \frac{{L}_{2} - {W}_{b}}{{W}_{c}} \leq 2.1 \qquad [ Equation 2 ]$$

where L₂ is an extension length of the second cover portion, W_{b} is a thickness of the base portion, and W_{c} is a thickness of the battery cell.

In one embodiment of the battery assembly, a pair of battery cells disposed adjacent to the barrier may have folding directions of folding portions that are different from each other.

In one embodiment of the battery assembly, the base portion may comprise a reinforcement member.

In one embodiment of the battery assembly, the barrier may suppress propagation of heat or flame.

According to one aspect of the present disclosure, a barrier capable of providing improved blocking and suppression effects against propagation of heat or flame in the event of thermal runaway may be provided.

According to another aspect of the present disclosure, a barrier capable of protecting a battery cell in multiple directions from heat or flame generated in the event of thermal runaway may be provided when inserted between battery cells.

According to still another aspect of the present disclosure, a battery assembly with improved safety may be provided without a separate design change by including the above-described barrier.

Meanwhile, the present disclosure may be widely applied in fields of green technology such as electric vehicles (EV), battery charging stations, energy storage systems (ESS), photovoltaics, and wind power, which utilize batteries. In addition, the present disclosure may be used in eco-friendly mobility, including electric vehicles and hybrid vehicles, for preventing climate change by suppressing air pollution and emission of greenhouse gases.

### BRIEF DESCRIPTION OF THE DRAWINGS

FIG. 1 is a structural view illustrating a barrier according to one embodiment of the present disclosure.

FIG. 2 is a cross-sectional view illustrating a barrier according to one embodiment of the present disclosure.

FIG. 3 is a cross-sectional view illustrating a barrier according to one embodiment of the present disclosure.

FIG. 4 is a structural view illustrating a barrier according to another embodiment of the present disclosure.

FIG. 5 is a cross-sectional view illustrating a barrier according to another embodiment of the present disclosure.

FIG. 6 is a structural view illustrating a barrier according to still another embodiment of the present disclosure.

FIG. 7 is a cross-sectional view illustrating a barrier according to still another embodiment of the present disclosure.

FIG. 8 is an exploded perspective view illustrating an example of a battery assembly according to one embodiment of the present disclosure.

FIG. 9 is a structural view illustrating a battery cell according to one embodiment of the present disclosure.

FIG. 10 is a cross-sectional view taken in a second direction (DR2), illustrating a configuration in which a plurality of battery cells and barriers are stacked and accommodated in a battery assembly according to one embodiment of the present disclosure.

FIG. 11 is an enlarged view of region A of FIG. 10.

FIG. 12 is an enlarged view of region B of FIG. 10.

FIG. 13 is a cross-sectional view taken from one side in a third direction (DR3), illustrating a configuration in which a plurality of battery cells and barriers are stacked and accommodated in a battery assembly according to one embodiment of the present disclosure.

FIG. 14 is a cross-sectional view taken from the other side in the third direction (DR3), illustrating a configuration in which a plurality of battery cells and barriers are stacked and accommodated in a battery assembly according to one embodiment of the present disclosure.

### DETAILED DESCRIPTION

The embodiments described in the present specification may be modified into various other forms, and the technical features according to one embodiment are not limited to the embodiments described below. Furthermore, throughout the specification, expressions such as “comprise,” “include,” “contain,” or “have” are not intended to exclude other elements unless specifically stated otherwise, and are intended to include additional elements, materials, or processes that are not expressly enumerated.

In the present specification, the terms “identical” or “uniform” may refer to being the same or uniform within an allowable margin of error unless otherwise specified. For example, when certain configurations or property values are described as being the same, it may mean that two comparative objects are completely identical or identical within a permissible error range. In one example, the property values may be considered identical when the difference between the measured values of objects is less than about 5%, specifically less than 3%, and more specifically less than 1%.

In the present specification, when two objects are described as being perpendicular or parallel to each other, it includes not only being geometrically perpendicular or parallel but also being within a slight margin of error.

The numerical ranges used in the present specification include the lower and upper limits and all values therebetween, all increments logically derived from the form and width of the defined range, all values bounded by double limitations, and all possible combinations of upper and lower limits defined in different forms.

Unless otherwise defined in the present specification, the term “about” may be considered to refer to a value within 30%, 25%, 20%, 15%, 10%, or 5% of the stated value.

In the present specification, the expressions “first,” “second,” “third,” etc. used before a component name are merely to avoid confusion between the components, and are not intended to imply order, importance, or superiority/inferiority between the components. For example, an invention comprising only the second component without the first component may also be implemented.

In the present specification, a configuration defined as “ . . . portion” may refer to a single component or an unrestricted set of two or more identical or similar components that share a functional characteristic.

In the present specification, the term “disposed” may refer without limitation to a positional relationship in which one object is placed adjacent to another. As a non-limiting example, it may include simply positioning at least a part of one object in contact with at least a part of another object in any space, or adhering them together using an adhesive material, or fusion bonding by applying heat, pressure, etc.

In the present specification, the term “cover” may refer without limitation to a functional or structural relationship in which one object is disposed at least adjacent to another object so as to block or mitigate an external factor that may act on the other object.

In the present specification, the terms “first direction (DR1),” “second direction (DR2),” and “third direction (DR3)” may each refer to one direction forming a mutually perpendicular orthogonal coordinate system in three-dimensional space.

The term “secondary battery” as used in the present specification may refer to a battery that generates electrical energy through an oxidation-reduction reaction when cations, specifically lithium ions, are inserted or extracted from a positive electrode or a negative electrode. Specifically, the secondary battery may refer to any one of lithium cobalt batteries, lithium high-nickel batteries, lithium iron phosphate batteries, lithium ion batteries, lithium polymer batteries, lithium sulfur batteries, nickel metal hydride batteries, nickel cadmium batteries, sodium batteries, and all-solid-state batteries. As an example, the term “secondary battery” may refer to a lithium ion secondary battery, but is not necessarily limited thereto.

The term “battery cell” as used in the present specification may refer to a basic unit of a secondary battery that can be charged and discharged with electrical energy.

Hereinafter, the present disclosure will be described in detail. However, the description is merely illustrative, and the present disclosure is not limited to the specific embodiments described.

### Barrier

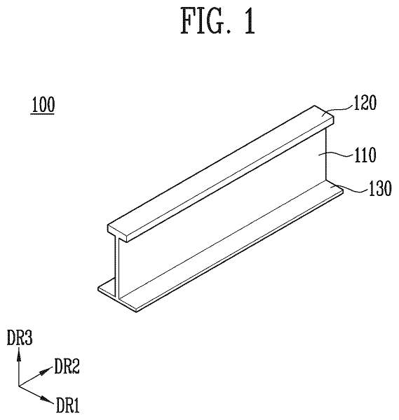

FIG. 1 is a structural view illustrating a barrier according to one embodiment of the present disclosure.

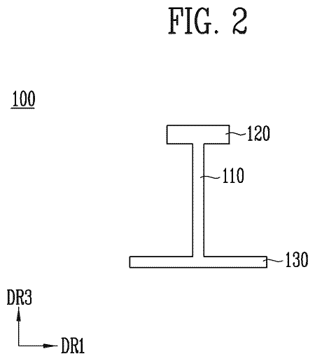

FIG. 2 is a cross-sectional view illustrating a barrier according to one embodiment of the present disclosure.

According to one embodiment of the present disclosure, a barrier 100 is a barrier disposed between at least one pair of adjacent battery cells 200 among a plurality of stacked battery cells 200, and comprises: a base portion 110 having a sheet shape; a first cover portion 120 and a second cover portion 130 respectively extending from at least one side of the base portion 110; wherein an extension length of the first cover portion 120 may be shorter than an extension length of the second cover portion 130.

In one embodiment, the barrier 100 may suppress or mitigate propagation of heat or flame.

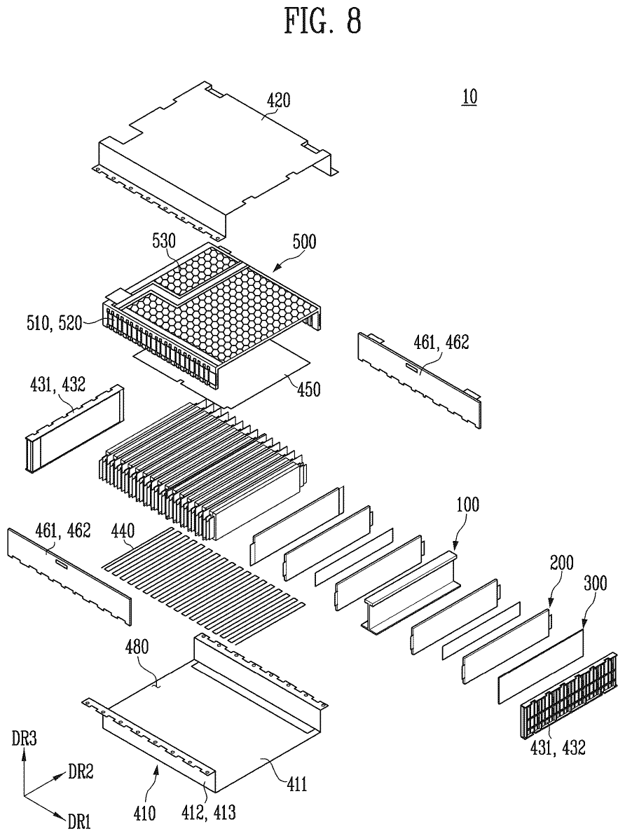

In one embodiment, as will be described below with reference to FIGS. 8 to 14, the barrier 100 may be disposed between at least one pair of adjacent battery cells 200 among the plurality of stacked battery cells 200 to protect at least a portion of the battery cells 200. Details thereon will be described below.

In one embodiment, the base portion 110 may have a sheet shape. Referring to FIGS. 1 and 2, in one embodiment, the base portion 110 may be formed to be parallel to an arbitrary plane including a second direction DR2 and a third direction DR3. Meanwhile, in an exemplary embodiment, the base portion 110 may have a shape in which the extension length in the third direction DR3 is longer than the extension length in the second direction DR2, but is not necessarily limited thereto.

In one embodiment, although the base portion 110 may have a sheet shape, it may be partially modified to include a curved surface or the like as needed.

In one embodiment, the base portion 110 may have heat insulating, heat resistant, insulating, and fire resistant properties so as to perform a function of suppressing propagation of heat or flame.

In one embodiment, the base portion 110 may comprise at least one of a fiber or an inorganic material.

In one embodiment, the fiber may comprise at least one selected from inorganic fibers and organic fibers. Specifically, the inorganic fibers may comprise at least one selected from silica fiber, alumina fiber, silica-alumina fiber, glass fiber, ceramic fiber, and basalt fiber, and the organic fibers may comprise aramid fiber.

In an exemplary embodiment, the fiber may be in the form of long fiber or short fiber. When the fiber is in the form of long fiber, the base portion 110 may comprise a woven structure of the fiber. Through the woven structure, the base portion 110 may be configured to include a woven or NCF fabric, but is not necessarily limited thereto. Meanwhile, the short fiber may correspond to a fiber that does not include long fiber. The diameter and length of the long fiber and/or short fiber are not particularly limited.

In one embodiment, the inorganic material may comprise at least one selected from the group consisting of mica, graphite, aluminum hydroxide, magnesium hydroxide, wollastonite, and aerogel.

In one embodiment, the base portion 110 may comprise mica.

According to one embodiment of the present disclosure, referring to FIGS. 1 and 2, the first cover portion 120 may extend perpendicularly from one side of the base portion 110, and the second cover portion 130 may extend perpendicularly from the other side of the base portion 110. In this case, the one side and the other side may refer to any two opposing lateral ends of the base portion 110.

As described above, the base portion 110 may be formed to be parallel to an arbitrary plane including the second direction DR2 and the third direction DR3. Meanwhile, in an exemplary embodiment, the one side and the other side may refer to both sides of the base portion 110 parallel to the second direction DR2, but are not necessarily limited thereto.

In one embodiment, the first cover portion 120 and the second cover portion 130 may have a sheet shape. However, as needed, at least a portion thereof may be modified to include a curved surface or the like.

Referring to FIGS. 1 and 2, the first cover portion 120 and the second cover portion 130 may be formed to be parallel to an arbitrary plane including the first direction DR1 and the second direction DR2. That is, the first cover portion 120 and the second cover portion 130 may be formed to be parallel to each other at both opposing sides of the base portion 110.

In one embodiment, the base portion 110 may be connected to central portions of the first cover portion 120 and the second cover portion 130. The central portions may refer to regions including straight lines located at the center of the first cover portion 120 and the second cover portion 130 respectively, among arbitrary straight lines extending along the second direction DR2 in the first cover portion 120 and the second cover portion 130. That is, through such a connection relationship, the cross-section of the barrier 100 may be formed to have an “H” or “I” shape, as illustrated in FIG. 2.

In one embodiment, portions where the base portion 110 and the first cover portion 120 and/or the base portion 110 and the second cover portion 130 are connected may be connected to form right angles. Alternatively, the portions where the base portion 110 and the first cover portion 120 and/or the base portion 110 and the second cover portion 130 are connected may be connected to be partially rounded. Alternatively, the base portion 110, the first cover portion 120, and/or the second cover portion 130 may be integrally formed.

In one embodiment, the first cover portion 120 and the second cover portion 130 may each independently comprise at least one selected from fiber and inorganic material. Since the fiber and inorganic material may include the same contents as described above for the configuration of the base portion 110, redundant description will be omitted below.

In one embodiment, the first cover portion 120 and the second cover portion 130 may have heat insulating, heat resistant, and fire resistant properties to perform a function of suppressing propagation of heat or flame.

That is, in one embodiment, the base portion 110, the first cover portion 120, and the second cover portion 130 may each independently comprise at least one selected from fiber and inorganic material. In one embodiment, the base portion 110, the first cover portion 120, and the second cover portion 130 may all be formed of the same material. In one embodiment, the base portion 110, the first cover portion 120, and the second cover portion 130 may all comprise mica.

As will be described below, the first cover portion 120 and the second cover portion 130 may be disposed to respectively cover at least a portion of a first sub-surface 233a and a second sub-surface 233b of the battery cell 200. That is, beyond the configuration of the base portion 110 that covers the main surface 231 of the battery cell 200, the first cover portion 120 and the second cover portion 130 may also be configured to block a path of heat or flame propagation in the third direction DR3 within the battery assembly 10, which may occur from one of the battery cells 200 during a thermal runaway event. That is, referring to FIGS. 1, 2, and the descriptions below, not only can the heat or flame propagation path in the first direction DR1 be blocked, but also the heat or flame propagation path in the third direction DR3 can be effectively blocked.

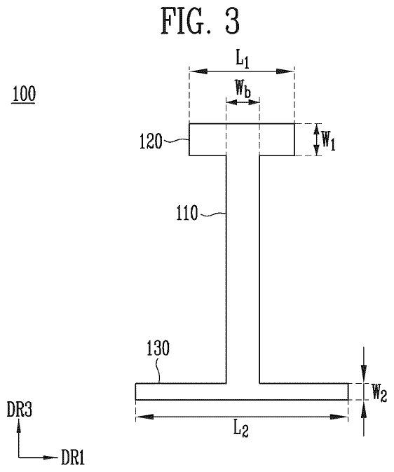

FIG. 3 is a cross-sectional view illustrating a barrier according to one embodiment of the present disclosure.

According to one embodiment, the thickness of the base portion 110 may be 1 mm to 5 mm. In a specific embodiment, the thickness of the base portion 110 may be 2 mm to 3 mm, more specifically 2.3 mm to 2.8 mm, and even more specifically 2.5 mm. When the thickness of the base portion 110 is less than the above-described range, the effect of blocking the propagation of heat or flame to adjacent cells during a thermal runaway event in the battery may be negligible. On the other hand, when the thickness of the base portion 110 exceeds the above-described range, it may be difficult to expect significant improvement in the propagation-blocking effect compared to the increase in the thickness or weight of the barrier 100, which may result in inferior energy efficiency per volume or per weight of the battery assembly 10 including the barrier.

Referring to FIG. 3, in one embodiment, the thickness of the base portion 110 may have the same value as the distance in the first direction DR1 in the sheet-shaped base portion 110. That is, it may correspond to the value indicated as “W_{b}” in FIG. 3.

In one embodiment, the thickness of the first cover portion 120 may be greater than the thickness of the second cover portion 130.

Referring to FIG. 3, in one embodiment, the thicknesses of the first cover portion 120 and the second cover portion 130 may have the same value as the distance in the third direction DR3 in the sheet-shaped first cover portion 120 and second cover portion 130. That is, the value indicated as “W₁” in FIG. 3 may correspond to the thickness of the first cover portion 120, and the value indicated as “W₂” in FIG. 3 may correspond to the thickness of the second cover portion 130. From this perspective, the relationship W₁>W₂ may be satisfied.

In a specific embodiment, the thickness of the first cover portion 120 may be 1.8 times to 2.2 times the thickness of the second cover portion 130. In a more specific embodiment, the thickness of the first cover portion 120 may be 2.0 times the thickness of the second cover portion 130. From this perspective, the relationship 1.8<W₁/W₂<2.2 may be satisfied. Or more specifically, the relationship W₁/W₂=2.0 may be satisfied.

The relationship between the thicknesses W₁ of the first cover portion 120 and W₂ of the second cover portion 130 as described above will be described in more detail in the description of the battery assembly according to one embodiment of the present disclosure.

In one embodiment, the extension length of the first cover portion 120 may be shorter than the extension length of the second cover portion 130.

Referring again to FIG. 3, in one embodiment, the extension lengths of the first cover portion 120 and the second cover portion 130 may have the same value as the extension distance in the first direction DR1 in the sheet-shaped first cover portion 120 and second cover portion 130. That is, the value indicated as “L₁” in FIG. 3 may correspond to the extension length of the first cover portion 120, and the value indicated as “L₂” in FIG. 3 may correspond to the extension length of the second cover portion 130. From this perspective, the relationship L₁<L₂ may be satisfied.

In a specific embodiment, the extension length of the first cover portion 120 may be 0.4 times to 0.6 times the extension length of the second cover portion 130. In a more specific embodiment, the extension length of the first cover portion 120 may be 0.5 times the extension length of the second cover portion 130. From this perspective, the relationship 0.4<L₁/L₂<0.6 may be satisfied. Or more specifically, the relationship L₁/L₂=0.5 may be satisfied.

The relationship between the extension lengths L₁ of the first cover portion 120 and L₂ of the second cover portion 130 as described above will be described in more detail in the description of the battery assembly according to one embodiment of the present disclosure.

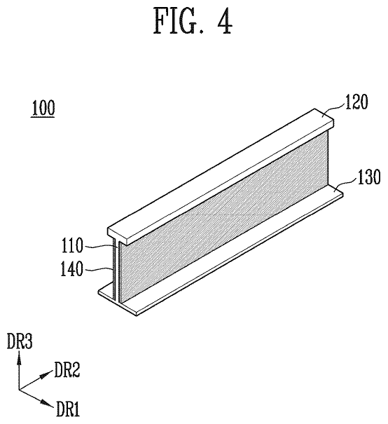

FIG. 4 is a structural view illustrating a barrier according to another embodiment of the present disclosure.

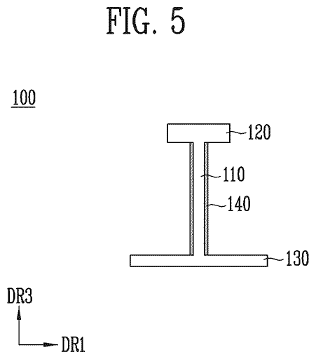

FIG. 5 is a cross-sectional view illustrating a barrier according to another embodiment of the present disclosure.

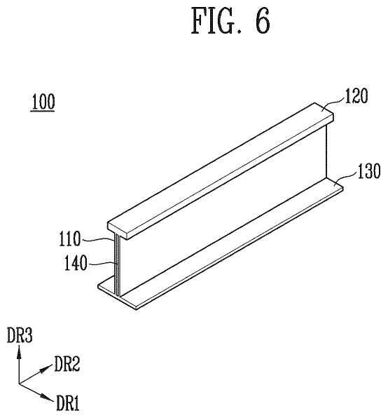

FIG. 6 is a structural view illustrating a barrier according to still another embodiment of the present disclosure.

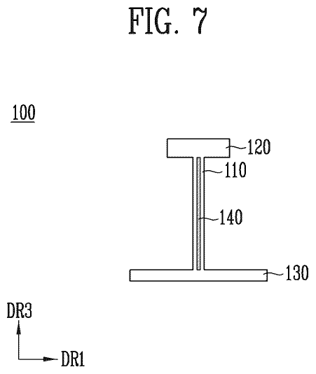

FIG. 7 is a cross-sectional view illustrating a barrier according to still another embodiment of the present disclosure.

According to one embodiment, referring to FIGS. 4 to 7, the base portion 110 may further include a reinforcement member 140.

In one embodiment, the reinforcement member 140 may further reinforce mechanical properties in the direction of the base portion 110 of the barrier 100.

In one embodiment, the reinforcement member 140 may include a surface pressure member that performs a surface pressure function to mitigate or offset pressure applied to adjacent cells due to physical deformation in the event of swelling of any one battery cell 200 during continuous use of the battery. To this end, the surface pressure member may include an elastic material that is compressed when an external force is applied and restored when the external force is removed.

In one embodiment, the surface pressure member may include at least one selected from the group consisting of silicone, polyurethane (PU), acrylic, EPDM (Ethylene-Propylene Diene Monomer), EVA (Ethylene Vinyl Acetate), isoprene rubber, butadiene-based rubber, chloroprene rubber, and butyl rubber. In one embodiment, the butadiene-based rubber may refer to butadiene rubber (BR), styrene-butadiene rubber (SBR), acrylonitrile-butadiene rubber (NBR), and ABS resin.

In one embodiment, the reinforcement member 140 may include an expansion member having thermal insulation, heat resistance, electrical insulation, and fire resistance properties and configured to seal a heat or flame movement path by expanding when in contact with heat or flame. To this end, the expansion member may include a thermally expandable material.

In one embodiment, the expansion member may expand to 150% to 800% of its volume at room temperature at a temperature of 150° C. to 300° C.

In one embodiment, the expansion member may include at least one selected from the group consisting of expandable graphite, silicates, and phosphorus-based flame retardants.

In one embodiment, the silicate may include at least one selected from the group consisting of sodium silicate, potassium silicate, and lithium silicate.

In one embodiment, the reinforcement member 140 may include at least one of a surface pressure member and an expansion member. In a specific embodiment, the reinforcement member 140 may include only one of the surface pressure member and the expansion member or may include both the surface pressure member and the expansion member.

In one embodiment, the reinforcement member 140 may have a sheet shape. Referring to FIGS. 4 to 7, in one embodiment, the reinforcement member 140 may be formed to be parallel to an arbitrary plane including the second direction DR2 and the third direction DR3. In an exemplary embodiment, the reinforcement member 140 may have a shape in which the extension length in the third direction DR3 is greater than that in the second direction DR2, but is not necessarily limited thereto.

In one embodiment, the reinforcement member 140 may have a sheet shape but may be partially deformed to include a curved surface if necessary.

Referring to FIGS. 4 and 5, in one embodiment, the reinforcement member 140 may be formed with an area corresponding to the base portion 110 and may be formed to be attached to at least one of both surfaces of the base portion 110 in the first direction DR1. In this case, each reinforcement member 140 attached to each surface may independently include at least one of the surface pressure member and the expansion member. In a specific embodiment, one reinforcement member 140 attached to one surface of the base portion 110 may include a surface pressure member, and the other reinforcement member 140 attached to the other surface of the base portion 110 may include an expansion member. Alternatively, the one reinforcement member 140 and the other reinforcement member 140 may each include both a surface pressure member and an expansion member. Meanwhile, unlike what is shown in FIGS. 4 and 5, the reinforcement member 140 may be formed to be attached to at least one of both surfaces of the base portion 110 and may be attached with an area corresponding to only a part of the base portion 110.

Referring to FIGS. 6 and 7, in one embodiment, the reinforcement member 140 may be formed to be embedded within the base portion 110. In this case, the reinforcement member 140 may include at least one of a surface pressure member and an expansion member. In a specific embodiment, the reinforcement member 140 may include only one of the surface pressure member and the expansion member. Alternatively, the reinforcement member 140 may include both the surface pressure member and the expansion member.

In one embodiment, when the base portion 110 includes the reinforcement member 140, the thickness of the base portion 110 may be 1 mm to 5 mm. In a specific embodiment, the thickness of the base portion 110 may be 2 mm to 3 mm, more specifically 2.3 mm to 2.8 mm, and even more specifically 2.5 mm. That is, even when the base portion 110 includes the reinforcement member 140, the thicknesses of each element may be determined within the above-described range in a non-limiting manner in consideration of the configuration of the additionally included reinforcement member 140.

As described in the above embodiments, the barrier 100 according to one embodiment of the present disclosure can effectively suppress the propagation of heat or flame in various paths during a thermal runaway event in the battery, so that when applied to the battery assembly 10, it can exhibit an improved effect of suppressing the propagation of heat or flame and, at the same time, effectively mitigate the surface pressure caused by swelling that may occur during continuous use of the battery.

Meanwhile, FIGS. 1 to 7 are illustrated for convenience of explanation of the barrier 100 according to one embodiment of the present disclosure, and the shapes, thicknesses, sizes, colors, and shades of the illustrated barrier 100 and each component are arbitrary and may be variously configured as needed without departing from the definitions of the present disclosure.

### Battery Assembly

FIG. 8 is an exploded perspective view illustrating an example of a battery assembly according to one embodiment of the present disclosure.

According to one embodiment of the present disclosure, the battery assembly 10 includes: a plurality of battery cells 200 stacked along a first direction DR1; a barrier 100 disposed between at least one pair of adjacent battery cells 200 among the plurality of battery cells 200; and a receiving case 400 configured to accommodate the plurality of battery cells 200 and the barrier 100. The barrier 100 may include: a sheet-shaped base portion 110; a first cover portion 120 extending from one side of the base portion 110 along the first direction DR1; and a second cover portion 130 extending from the other side of the base portion 110 along the first direction DR1.

In one embodiment, each of the plurality of battery cells 200 includes: an electrode assembly 210; an electrode lead 220 electrically connected to the electrode assembly 210 and protruding in a second direction DR2 intersecting the first direction DR1; and a cell case 230 accommodating the electrode assembly 210 therein and including a first sub-surface 233a and a second sub-surface 233b that cover the electrode assembly 210 in a third direction DR3 intersecting both the first direction DR1 and the second direction DR2. At least a portion of the first sub-surface 233a includes a folding portion 235. The barrier 100 may be disposed such that the base portion 110 covers the battery cell 200 in the first direction DR1, the first cover portion 120 covers at least a portion of the first sub-surface 233a, and the second cover portion 130 covers at least a portion of the second sub-surface 233b.

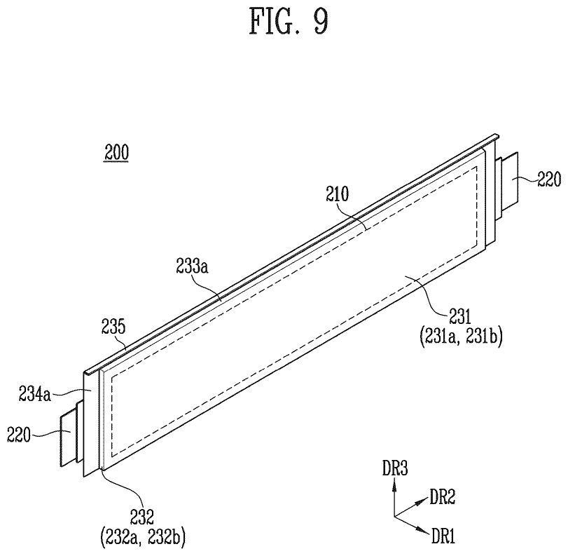

FIG. 9 is a structural view illustrating a battery cell according to one embodiment of the present disclosure.

Referring to FIG. 9, in one embodiment, the plurality of battery cells 200 may be stacked along the first direction DR1.

In one embodiment, each of the plurality of battery cells 200 may include: an electrode assembly 210; an electrode lead 220 electrically connected to the electrode assembly 210; and a cell case 230 accommodating the electrode assembly 210 therein.

In one embodiment, each of the plurality of battery cells 200 may include a cathode, an anode, a separator, and an electrolyte as main components. The electrode assembly 210 may include the cathode, the anode, and the separator.

According to an exemplary embodiment, the cathode may include a cathode current collector and a cathode active material applied to at least one surface of the cathode current collector.

According to an exemplary embodiment, the anode may include an anode current collector and an anode active material applied to at least one surface of the anode current collector.

According to an exemplary embodiment, the cathode and the anode may further include a binder and a conductive material to improve mechanical stability and electrical conductivity.

According to an exemplary embodiment, each battery cell 200 may further include a separator configured to prevent electrical short-circuit between the cathode and the anode and to allow ion flow. The separator may include, for example, a porous polymer film or a porous nonwoven fabric.

Accordingly, in such an embodiment, the electrode assembly 210 may have a stacked structure in which the cathode, the separator, and the anode are stacked in a predetermined stacking direction. The cathode, separator, and anode may be stacked using a stacking, stack-folding, or Z-stacking method.

According to an exemplary embodiment, each battery cell 200 may include an electrolyte for impregnating the electrode assembly 210. The electrolyte may be a non-aqueous electrolyte. The electrolyte may include a lithium salt and an organic solvent, and may further include additives as needed.

Meanwhile, according to another exemplary embodiment, each battery cell 200 may further include a solid electrolyte layer including a solid-state electrolyte. Accordingly, in such an embodiment, the electrode assembly 210 may have a stacked structure in which the cathode, the solid electrolyte layer, and the anode are stacked in a predetermined stacking direction.

In one embodiment, the electrode lead 220 may be electrically connected to the cathode and the anode and may protrude outside the cell case 230 to electrically connect the battery cell 200 to the outside.

In one embodiment, the electrode lead 220 may include a cathode lead 221 electrically connected to the cathode and an anode lead 222 electrically connected to the anode. The cathode lead 221 and the anode lead 222 may each protrude outside the cell case 230 to electrically connect the cathode and the anode of the battery cell 200 to the outside.

In one embodiment, when the plurality of battery cells 200 are stacked in the first direction DR1, the electrode lead 220 may be disposed in the second direction DR2. Meanwhile, as illustrated in FIG. 9, the cathode lead 221 and the anode lead 222 may be disposed in the same direction and may be formed to face each other or in opposite directions (i.e., with respect to the second direction DR2, they may face +DR2 and −DR2, respectively). However, they are not necessarily limited thereto, and the cathode lead 221 and the anode lead 222 may be disposed in the same direction and oriented in the same direction (i.e., both facing +DR2 or both facing −DR2 with respect to the second direction DR2).

In one embodiment, the cell case 230 may accommodate the electrode assembly 210 therein and may be configured to cover the electrode assembly 210 from the external environment.

In one embodiment, the cell case 230 may be configured as a pouch-type case.

Referring to FIG. 9, in one embodiment, the cell case 230 may include a main surface 231 that covers the electrode assembly 210 in the first direction DR1, a lead surface 232 that covers the electrode assembly 210 in the second direction DR2 and allows at least a portion of the electrode lead 220 to be disposed therein, and a sub-surface 233 that covers the electrode assembly 210 in the third direction DR3. In one embodiment, the main surface 231 may include a first main surface 231a and a second main surface 231b facing each other along the first direction DR1, the lead surface 232 may include a first lead surface 232a and a second lead surface 232b facing each other along the second direction DR2, and the sub-surface 233 may include a first sub-surface 233a and a second sub-surface 233b facing each other along the third direction DR3. The main surface 231, the lead surface 232, and the sub-surface 233 may be combined to define a receiving space for accommodating the electrode assembly 210 therein.

Referring again to FIG. 9, in one embodiment, the cell case 230 may include a first sealing portion 234a formed on at least a portion of the first lead surface 232a and the second lead surface 232b and a second sealing portion 234b formed on at least a portion of the first sub-surface 233a. The first sealing portion 234a and the second sealing portion 234b may refer to joint regions formed along the periphery of the cell case 230 in the manufacturing process. At least a portion of the second sealing portion 234b may be fixed in a folded state and may be referred to as the folding portion 235.

In one embodiment, the barrier 100 may be configured to suppress or mitigate the propagation of heat or flame.

In one embodiment, the barrier 100 may be disposed between at least one pair of adjacent battery cells 200 among the plurality of battery cells 200. The barrier 100 may include: a sheet-shaped base portion 110; a first cover portion 120 extending from one side of the base portion 110 along the first direction DR1; and a second cover portion 130 extending from the other side of the base portion 110 along the first direction DR1.

In one embodiment, the base portion 110 may be configured to perform a function of suppressing the propagation of heat or flame and may have thermal insulation, heat resistance, electrical insulation, and flame retardancy.

In one embodiment, the base portion 110 may include at least one selected from fibers and inorganic materials.

In one embodiment, the first cover portion 120 and the second cover portion 130 may be sheet-shaped. However, if necessary, at least a portion may be modified to include a curved surface.

Referring to FIGS. 1, 2, and 8, the first cover portion 120 and the second cover portion 130 may be formed to be parallel to an arbitrary plane including the first direction DR1 and the second direction DR2. That is, the first cover portion 120 and the second cover portion 130 may be formed to be parallel to each other on opposite sides of the base portion 110.

In one embodiment, the base portion 110 may be connected to the central portions of the first cover portion 120 and the second cover portion 130. The central portion may refer to a region including a straight line located at the center of the first cover portion 120 and the second cover portion 130 along the second direction DR2. Thus, through such a connection, the cross-section of the barrier 100 may be formed in an “H” shape or a “I” shape, as illustrated in FIG. 2 or FIGS. 10 to 12.

In one embodiment, the connection portion between the base portion 110 and the first cover portion 120 and/or between the base portion 110 and the second cover portion 130 may be connected at a right angle. Alternatively, the connection portion may be formed with a rounded edge. Alternatively, the base portion 110, the first cover portion 120, and/or the second cover portion 130 may be integrally formed.

In one embodiment, the first cover portion 120 and the second cover portion 130 may each independently include at least one selected from fibers and inorganic materials. The fibers and inorganic materials may include the same features as described above with respect to the configuration of the base portion 110, and thus repeated descriptions will be omitted.

In one embodiment, the first cover portion 120 and the second cover portion 130 may have thermal insulation, heat resistance, and flame retardancy to perform the function of suppressing the propagation of heat or flame.

That is, in one embodiment, the base portion 110, the first cover portion 120, and the second cover portion 130 may each independently include at least one of fibers or inorganic materials. In one embodiment, all of the base portion 110, the first cover portion 120, and the second cover portion 130 may be made of the same material. In one embodiment, all of the base portion 110, the first cover portion 120, and the second cover portion 130 may include mica.

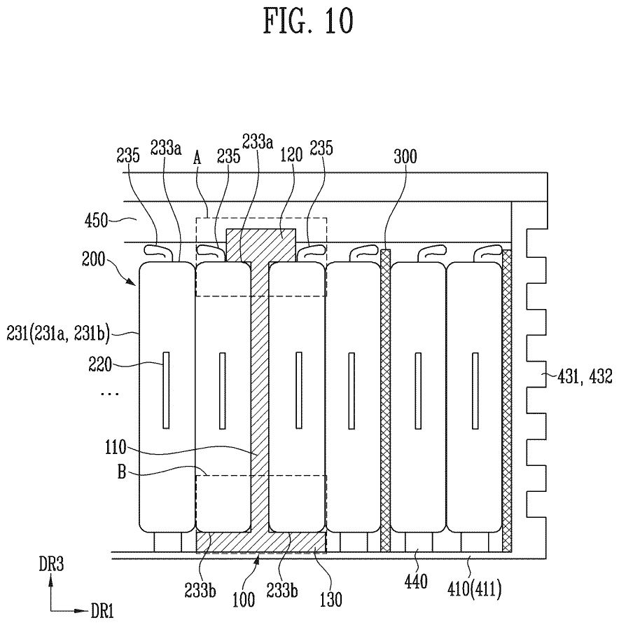

As illustrated in FIGS. 10 to 14, the first cover portion 120 and the second cover portion 130 may be disposed to respectively cover at least portions of the first sub-surface 233a and the second sub-surface 233b of the battery cell 200. That is, in addition to the base portion 110 that covers the main surface 231 of the battery cell 200, the first cover portion 120 and the second cover portion 130 may be configured to also block a path along the third direction DR3 in which heat or flame may propagate in the battery assembly 10 during a thermal runaway event. Thus, referring to FIGS. 1, 2, and 10 to 14, the structure may effectively block the propagation path of heat or flame not only in the first direction DR1 but also in the third direction DR3.

Meanwhile, the battery assembly 10 may further include a sub-pad 300 disposed between at least one pair of adjacent battery cells 200 among the plurality of battery cells 200, in addition to the barrier 100.

In one embodiment, the sub-pad 300 may have thermal insulation, heat resistance, electrical insulation, and flame retardancy to perform the function of suppressing the propagation of heat or flame.

In one embodiment, the sub-pad 300 may include at least one selected from fibers or inorganic materials. In one embodiment, the sub-pad 300 may be made of the same material as the base portion 110 and/or the first cover portion 120 and the second cover portion 130.

In one embodiment, the sub-pad 300 may be configured to cover the main surface 231 of the battery cell 200, similar to the base portion 110 of the barrier 100, and may block the heat or flame propagation path in the first direction DR1 together with the barrier 100.

Referring again to FIG. 8, in one embodiment, the battery assembly 10 may include a receiving case 400 configured to accommodate the plurality of battery cells 200 and the barrier 100.

In one embodiment, the receiving case 400 may include a receiving body 410 forming a part of a receiving space 480 configured to accommodate the plurality of battery cells 200 and the barrier 100, and a receiving cover 420 coupled to the receiving body 410 to together form the receiving space 480.

Referring to FIG. 8, in one embodiment, the plurality of battery cells 200 may be stacked along the first direction DR1 inside the receiving body 410.

In one embodiment, the receiving case 400 may include an opened upper surface 4105 through which the plurality of battery cells 200 are accommodated; a receiving body 410 having the opened upper surface 4105; and a receiving cover 420 coupled to the receiving body 410 to close the opened upper surface 4105.

Accordingly, the receiving cover 420 may be coupled to the receiving body 410 to form an upper surface of the receiving space 480 or an upper surface of the receiving case 400. That is, the receiving cover 420 may be coupled to the receiving body 410 to close the opened upper surface 4105 and form the receiving space 480 together with the receiving body 410.

In one embodiment, the receiving space 480 may be formed inside the receiving body 410 and may include a space for accommodating a stack of the plurality of battery cells 200.

In one embodiment, the receiving body 410 may be formed in a channel shape or a U-shape with an open top. Referring to FIG. 8, both side surfaces 4107 and 4108 of the receiving body 410 facing each other along the first direction DR1 may also be open.

In one embodiment, the receiving body 410 may include a body bottom surface 411 forming a bottom surface of the receiving space 480 and body side surfaces 412 and 413 extending from corners (not shown) of the body bottom surface 411 along the first direction DR1 toward the receiving cover 420. Free ends of the body side surfaces 412 and 413 may be bent to form flanges (not shown), which may enable easy coupling with the receiving cover 420.

Meanwhile, in the above embodiments, the term “upper” may refer without limitation to a position located on one side of the third direction DR3, i.e., in the +DR3 direction based on FIG. 8.

In one embodiment, the battery assembly 10 may further include other components necessary for the operation of the battery assembly 10 in addition to the battery cell 200, the barrier 100, and the receiving case 400.

Referring again to FIG. 8, in one embodiment, the battery assembly 10 may further include end plates 431 and 432 at both ends of the battery cell stack along the first direction DR1. In a specific embodiment, the end plates 431 and 432 may be provided at both ends of the stack or formed in connection with both side surfaces 4107 and 4108 of the receiving body 410. In one embodiment, the end plates 431 and 432 may be configured to prevent the opposite sides of the stacked battery cells 200 from being exposed to the outside.

In one embodiment, the battery assembly 10 may further include a busbar assembly 500 including a busbar electrically connected to the plurality of battery cells 200.

In one embodiment, the busbar assembly 500 may further include busbar frames 510, 520, and 530 that support the busbar and the plurality of battery cells 200.

In one embodiment, the configuration including the busbar and the busbar frames 510, 520, and 530 may be referred to as the busbar assembly 500. In this case, the busbar assembly 500 may include a busbar electrically connected to the plurality of battery cells 200.

In one embodiment, the busbar assembly 500 may be electrically connected to the outside to store (or charge) electrical energy in the plurality of battery cells 200 or to supply (or discharge) the electrical energy stored in the plurality of battery cells 200 to the outside.

In one embodiment, the busbar assembly 500 may include a first busbar frame 510 and a second busbar frame 520 extending along the first direction DR1 with the plurality of battery cells 200 interposed therebetween.

In one embodiment, the busbar assembly 500 may further include a support frame 530 located on one side of the busbar assembly 500 and connecting the first busbar frame 510 and the second busbar frame 520.

In one embodiment, the support frame 530 may be configured to prevent deformation of and support the first busbar frame 510 and the second busbar frame 520. Further, in one embodiment, the support frame 530 may be configured to support the plurality of battery cells 200 in the third direction DR3.

In one embodiment, a portion of an electrical device for sensing and controlling the plurality of battery cells 200 may be disposed on the support frame 530.

Although FIG. 8 illustrates a case in which the electrode leads 220 of the battery cells 200 are formed in opposite directions, this is not necessarily limited thereto, and the electrode leads 220 of the battery cells 200 may be formed in the same direction as needed. In this case, the busbar frames 510, 520, and 530 may be electrically connected while being located on one side of the battery cells 200, for example, on the upper side of the battery cells 200.

Referring to FIG. 8, in one embodiment, the busbar assembly 500 may have a tunnel shape.

In one embodiment, the support frame 530 may be connected to the first busbar frame 510 and the second busbar frame 520 and may cover at least a portion of the plurality of battery cells 200 in the third direction DR3. Alternatively, the support frame 530 may be configured to cover all of the plurality of battery cells 200 in the third direction DR3.

In one embodiment, the busbar may be supported by the first busbar frame 510 and include a first busbar electrically connected to one of the electrode leads of the battery cells 200, and a second busbar supported by the second busbar frame 520 and electrically connected to the other one of the electrode leads of the battery cells 200.

In one embodiment, the first busbar and the second busbar may each be located in a direction farther from the plurality of battery cells 200 than the first busbar frame 510 and the second busbar frame 520. That is, they may be located closer to the body side surfaces 412 and 413 than the first and second busbar frames. In this case, each electrode lead of the battery cells 200 may be inserted into slit holes (not shown) formed in the first busbar and the second busbar and/or the first busbar frame 510 and the second busbar frame 520 to be electrically connected to the first and second busbars. However, this is not necessarily limited thereto, and each of the electrode leads may be electrically connected to the first and second busbars in a manner different from the above as needed.

In one embodiment, the battery assembly 10 may include insulating covers 461 and 462 disposed between the receiving case (specifically, the receiving body 410) and the busbar assembly 500 with respect to the second direction DR2.

In one embodiment, the insulating covers 461 and 462 may be configured to block electrical connection between the busbar assembly 500 and the receiving case 400. For this purpose, the insulating covers 461 and 462 may have electrical insulating properties.

In one embodiment, each of the insulating covers 461 and 462 may be located in a direction farther from the battery cells 200 than the first and second busbars. That is, each of the insulating covers 461 and 462 may be located closer to the body side surfaces 412 and 413 than the first and second busbars.

In one embodiment, the battery assembly 10 may include a sheet-shaped cover pad 450 located between the support frame 530 and the plurality of battery cells 200, and configured to further suppress the propagation of heat or flame in the third direction DR3 when a thermal runaway event occurs in at least one of the plurality of battery cells 200.

In one embodiment, the cover pad 450 may have thermal insulation, heat resistance, electrical insulation, and flame retardancy to perform the function of suppressing the propagation of heat or flame.

In one embodiment, the cover pad 450 may include at least one selected from fiber (wool) or inorganic materials.

In one embodiment, the fiber may include at least one selected from inorganic fibers or organic fibers. In a specific embodiment, the inorganic fibers may include at least one selected from silica fiber, alumina fiber, silica-alumina fiber, glass fiber, ceramic fiber, and basalt fiber, and the organic fibers may include aramid fiber.

In one embodiment, the inorganic material may include at least one selected from the group consisting of mica, graphite, aluminum hydroxide, magnesium hydroxide, wollastonite, and aerogel.

In one embodiment, the cover pad 450 may further include polyurethane, silicone, or the like.

In one embodiment, the battery assembly 10 may further include a heat dissipation portion 440 located between the body bottom surface 411 and the plurality of battery cells 200 and configured to transfer heat generated from the plurality of battery cells 200 to the outside of the battery assembly 10.

In one embodiment, the heat dissipation portion 440 may include an adhesive material having thermal conductivity.

In one embodiment, the heat dissipation portion 440 may bond the plurality of battery cells 200 to the body bottom surface 411. To this end, the heat dissipation portion 440 may be formed by being sprayed or applied in the form of a liquid composition onto the body bottom surface 411 and then cured, or may be formed in the form of a soft or hard sheet.

In one embodiment, the heat dissipation portion 440 may be formed to have a thickness of 0.1 mm to 1.0 mm. In a specific embodiment, the heat dissipation portion 440 may be formed to have a thickness of 0.3 mm to 0.6 mm. In another embodiment, the thickness of the heat dissipation portion 440 may be 0.8 times to 1.1 times the thickness of the second cover portion 130.

Meanwhile, FIG. 8 is shown for convenience of explanation and illustrates a battery module structure of the battery assembly 10. However, this is merely an example, and the battery assembly 10 according to the present disclosure is not limited thereto and may also be applied to a battery pack structure in which the module structures shown in FIG. 8 are assembled, or to a CTP (Cell to Pack) structure in which the battery cells 200, the barrier 100, and the case are directly received in the form of a pack without a general battery module structure.

FIG. 10 is a cross-sectional view taken in a second direction (DR2), illustrating a configuration in which a plurality of battery cells and barriers are stacked and accommodated in a battery assembly according to one embodiment of the present disclosure.

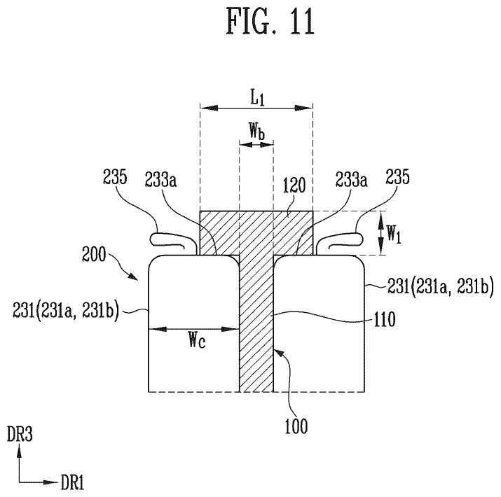

FIG. 11 is an enlarged view of region A of FIG. 10.

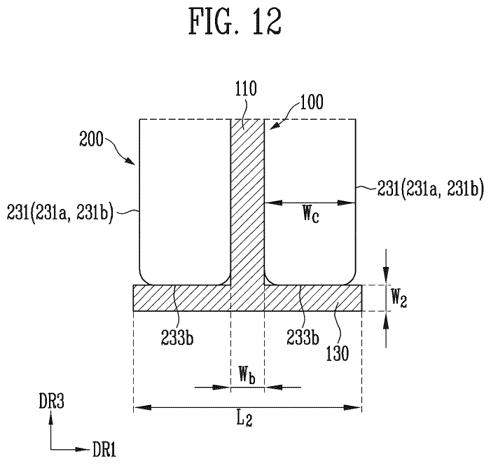

FIG. 12 is an enlarged view of region B of FIG. 10.

Referring again to FIGS. 10 to 12, as described above, the base portion 110 may cover at least a portion of the main surface 231 of the battery cell 200, and the first cover portion 120 and the second cover portion 130 may each be disposed to cover at least a portion of the first sub-surface 233a and the second sub-surface 233b of the battery cell 200, respectively. That is, in the barrier 100, the base portion 110 may block a path of heat or flame propagation in the first direction DR1, and the first cover portion 120 and the second cover portion 130 may block a path of heat or flame propagation in the third direction DR3.

In one embodiment, the thickness of the base portion 110 may be 1 mm to 5 mm. In a specific embodiment, the thickness of the base portion 110 may be 2 mm to 3 mm, more specifically 2.3 mm to 2.8 mm, and even more specifically 2.5 mm. If the thickness of the base portion 110 is less than the above-described range, the effect of blocking the propagation of heat or flame to adjacent cells during a thermal runaway event in the battery may be insignificant. On the other hand, if the thickness of the base portion 110 exceeds the above-described range, it may be difficult to expect a meaningful improvement in the above-mentioned propagation blocking effect relative to the increase in the thickness or weight of the barrier 100, thereby deteriorating the energy efficiency per volume or weight of the battery assembly 10 including the same.

Referring again to FIGS. 10 to 12, in one embodiment, the thickness of the base portion 110 may have the same value as the distance in the first direction DR1 of the sheet-shaped base portion 110. That is, it may correspond to the value denoted as “W_{b}” in FIGS. 11 and 12.

Referring again to FIGS. 10 to 12, in one embodiment, the first cover portion 120 may be disposed to cover at least a portion of the first sub-surface 233a of the battery cell 200, and the second cover portion 130 may be disposed to cover at least a portion of the second sub-surface 233b of the battery cell 200.

As previously described, at least a portion of the first sub-surface 233a may include the folding portion 235. In contrast, the second sub-surface 233b may not have a structure that particularly protrudes like the folding portion 235, so the cell case 230 may have a relatively smooth shape in the direction of the second sub-surface 233b.

Accordingly, as shown in FIGS. 10 to 12, in one embodiment, the thickness of the first cover portion 120 may be greater than that of the second cover portion 130. When the barrier 100 has the above-described structure and is arranged in the above-described positional relationship with the battery cell 200, the barrier 100 can effectively protect not only the main surface 231 of the battery cell 200 but also the first sub-surface 233a and the second sub-surface 233b, and in particular, can effectively protect the folding portion 235 formed on the first sub-surface 233a and its surrounding area, thereby further improving the heat or flame blocking effect.

Referring again to FIGS. 11 and 12, in one embodiment, the thicknesses of the first cover portion 120 and the second cover portion 130 may have the same values as the distances in the third direction DR3 of the sheet-shaped first cover portion 120 and second cover portion 130. That is, the value denoted as “W₁” in FIG. 11 may represent the thickness of the first cover portion 120, and the value denoted as “W₂” in FIG. 12 may represent the thickness of the second cover portion 130. From this viewpoint, the relationship W₁>W₂ may be satisfied.

In a specific embodiment, the thickness of the first cover portion 120 may be 1.8 times to 2.2 times the thickness of the second cover portion 130. More specifically, the thickness of the first cover portion 120 may be 2.0 times the thickness of the second cover portion 130. From this viewpoint, the relationship 1.8<W₁/W₂<2.2 may be satisfied, or more specifically, the relationship W₁/W₂=2.0 may be satisfied.

In one embodiment, the extension length of the first cover portion 120 may be smaller than that of the second cover portion 130.

Referring again to FIGS. 11 and 12, in one embodiment, the extension lengths of the first cover portion 120 and the second cover portion 130 may have the same values as the extension distances in the first direction DR1 of the sheet-shaped first cover portion 120 and second cover portion 130. That is, the value denoted as “L₁” in FIG. 11 may represent the extension length of the first cover portion 120, and the value denoted as “L₂” in FIG. 12 may represent the extension length of the second cover portion 130. From this viewpoint, the relationship L₁<L₂ may be satisfied.

In a specific embodiment, the extension length of the first cover portion 120 may be 0.4 times to 0.6 times the extension length of the second cover portion 130. More specifically, the extension length of the first cover portion 120 may be 0.5 times the extension length of the second cover portion 130. From this viewpoint, the relationship 0.4<L₁/L₂<0.6 may be satisfied, or more specifically, the relationship L₁/L₂=0.5 may be satisfied.

In one embodiment, the battery assembly 10 may satisfy a relation defined by the following Equation 1.

$$0.8 \leq \frac{{L}_{1} - {W}_{b}}{{W}_{c}} \leq 1.1 \qquad [ Equation 1 ]$$

In Equation 1, where L₁ is an extension length of the first cover portion 120, W_{b} is a thickness of the base portion 110, and W_{c} is a thickness of the battery cell 20.

That is, the value obtained by dividing the difference between the extension length L₁ of the first cover portion 120 and the thickness W_{b} of the base portion 110 by the thickness W_{c} of the battery cell 200 may be equal to or greater than 0.8 and less than 1.1.

Referring to FIGS. 11 and 12, in one embodiment, the thickness of the battery cell 200 may have the same value as the distance in the first direction DR1 of the battery cell 200. That is, the value denoted as “Wc” in FIGS. 11 and 12 may represent the thickness of the battery cell 200. Meanwhile, the thickness of the battery cell 200 may also be defined as the thickness of the cell case 230, or may be defined as the distance in the first direction DR1 of the projected shape when the first sub-surface 233a and/or the second sub-surface 233b is orthogonally projected onto an imaginary plane including the first direction DR1 and the second direction DR2.

When the extension length of the first cover portion 120, the thickness Wb of the base portion 110, and the thickness of the battery cell 200 satisfy the relationship defined by Equation 1 above, the barrier 100 disposed between a pair of battery cells 200 can easily cover the main surface 231 and the first sub-surface 233a of the adjacent battery cells 200, and in particular, can easily cover the area around the folding portion 235. Accordingly, the barrier 100 can effectively protect the adjacent battery cells 200 in both the first direction DR1 and the third direction DR3 during a thermal runaway event.

In one embodiment, the battery assembly 10 may satisfy a relationship defined by the following Equation 2:

$$1.8 \leq \frac{{L}_{2} - {W}_{b}}{{W}_{c}} \leq 2.1 \qquad [ Equation 2 ]$$

In Equation 2, where L₂ is an extension length of the second cover portion 130, W_{b} is a thickness of the base portion 110, and W_{c} is a thickness of the battery cell 200.

That is, the value obtained by dividing the difference between the extension length of the second cover portion 130 and the thickness of the base portion 110 by the thickness of the battery cell 200 may be equal to or greater than 1.8 and less than 2.1.

When the extension length of the second cover portion 130, the thickness of the base portion 110, and the thickness of the battery cell 200 satisfy the relationship defined by the above Equation 1, the barrier 100 disposed between a pair of battery cells 200 can easily cover the main surface 231 and the second sub-surface 233b of the adjacent battery cells 200. In particular, the barrier 100 can easily cover both the main surface 231 and the respective second sub-surfaces 233b of the adjacent battery cells 200. Accordingly, the barrier 100 can effectively protect the adjacent battery cells 200 in both the first direction DR1 and the third direction DR3 during a thermal runaway event.

In one embodiment, the battery assembly 10 may satisfy both the relationships defined by Equation 1 and Equation 2. In this case, the barrier 100 disposed between a pair of battery cells 200 can easily cover all of the main surface 231, the first sub-surface 233a, and the second sub-surface 233b of the adjacent battery cells 200. Accordingly, the barrier 100 can more effectively protect the adjacent battery cells 200 in both the first direction DR1 and the third direction DR3 during a thermal runaway event.

Meanwhile, as shown in FIG. 8, the first cover portion 120 and the second cover portion 130 may have second extension lengths in the second direction DR2, in addition to the above-described extension lengths L₁ and L₂. At this time, the respective second extension lengths of the first cover portion 120 and the second cover portion 130 may correspond to the extension length of the battery cell 200 in the second direction DR2.

In one embodiment, a pair of battery cells 200 disposed adjacent to the barrier 100 may have different folding directions of the folding portion 235.

Referring again to FIGS. 10 to 12, a pair of battery cells 200 disposed adjacent to the barrier 100 may have different folding directions of the folding portion 235. In a specific embodiment, the folding directions may be opposite to each other. Depending on the shape of the first cover portion 120 described above and the positional relationship between the barrier 100 and the battery cell 200, if the respective folding directions of the folding portions 235 of the pair of battery cells 200 adjacent to the barrier 100 are different, the covering effect of the first sub-surface 233a by the barrier 100 can be further improved. Accordingly, the protective effect in the third direction DR3 during a thermal runaway event can be further enhanced.

In one embodiment, the base portion 110 may further include a reinforcement member 140.

In one embodiment, the reinforcement member 140 may further enhance the mechanical properties in the direction of the base portion 110 of the barrier 100.

In one embodiment, the reinforcement member 140 may include a surface pressure member that performs a surface pressure function to relieve or offset the pressure applied to adjacent cells due to physical deformation when a swelling phenomenon occurs in any one of the battery cells 200 due to continuous use of the battery. For this purpose, the surface pressure member may include an elastic material that is compressed when an external force is applied and restored when the external force is released.

In one embodiment, the reinforcement member 140 may include an expansion member that has thermal insulation, heat resistance, electrical insulation, and flame resistance, and that seals a movement path of heat or flame by expanding upon contact with heat or flame. For this purpose, the expansion member may include a thermally expandable material.

In one embodiment, the reinforcement member 140 may include at least one of the surface pressure member and the expansion member. In a specific embodiment, the reinforcement member 140 may include only one of the surface pressure member and the expansion member, or may include both the surface pressure member and the expansion member.

The above description regarding the reinforcement member 140 described with reference to FIGS. 4 to 7 may be applied without limitation.

Through the configuration of the reinforcement member 140 described above, the barrier 100 can relieve or offset external force that may be applied in the first direction DR1, and/or maximize the effect of blocking heat or flame in the first direction DR1.

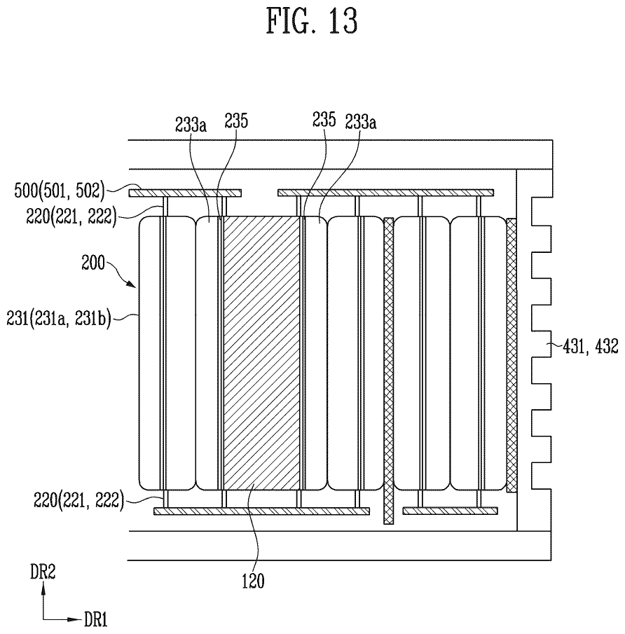

FIG. 13 is a cross-sectional view taken from one side in a third direction (DR3), illustrating a configuration in which a plurality of battery cells and barriers are stacked and accommodated in a battery assembly according to one embodiment of the present disclosure.

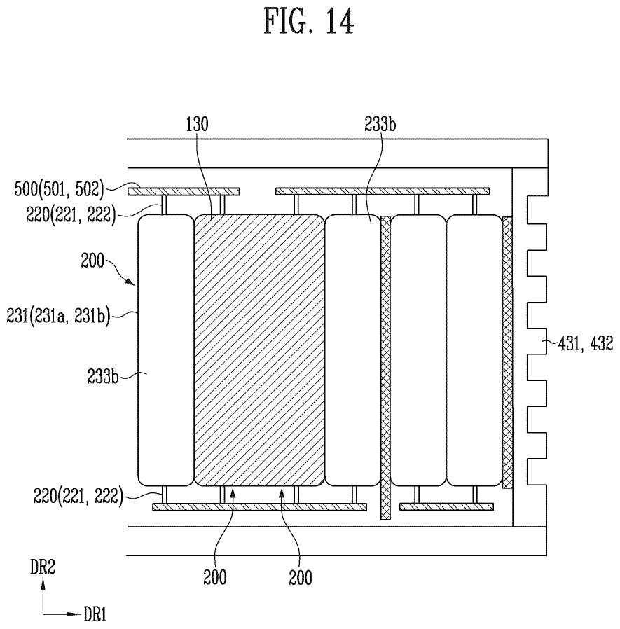

FIG. 14 is a cross-sectional view taken from the other side in the third direction (DR3), illustrating a configuration in which a plurality of battery cells and barriers are stacked and accommodated in a battery assembly according to one embodiment of the present disclosure.

Referring again to FIG. 13, FIG. 13 is a cross-sectional view as seen in the −DR3 direction based on FIG. 8 of a layout structure of a battery assembly in which a plurality of battery cells and barriers are stacked and accommodated according to one embodiment of the present disclosure, and FIG. 14 is a cross-sectional view as seen in the +DR3 direction based on FIG. 8 of a layout structure of a battery assembly in which a plurality of battery cells and barriers are stacked and accommodated according to one embodiment of the present disclosure.

As shown in FIG. 13, the barrier 100 may be disposed between at least one pair of adjacent battery cells 200 among the plurality of battery cells 200 and may be disposed to simultaneously cover at least a portion of the first sub-surfaces 233a of the pair of adjacent battery cells 200.

As shown in FIG. 14, the barrier 100 may be disposed between at least one pair of adjacent battery cells 200 among the plurality of battery cells 200 and may be disposed to simultaneously cover at least a portion of the second sub-surfaces 233b of the pair of adjacent battery cells 200.

In one embodiment, the plurality of battery cells 200 may be stacked such that one barrier 100 is disposed for every two battery cells 200 in the first direction DR1.

In one embodiment, the plurality of battery cells 200 may be stacked such that one barrier 100 is disposed for every four battery cells 200 in the first direction DR1.

In one embodiment, the plurality of battery cells 200 may be stacked such that one barrier 100 is disposed for every six battery cells 200 in the first direction DR1.

In one embodiment, the plurality of battery cells 200 may be stacked such that one barrier 100 is disposed for every eight battery cells 200 in the first direction DR1.

In one embodiment, the plurality of battery cells 200 may be stacked such that one barrier 100 is independently disposed for every two, four, six, or eight battery cells 200 in the first direction DR1. As a non-limiting example, among the plurality of battery cells 200 stacked in the first direction DR1, they may be stacked and arranged as four battery cells 200—barrier 100—eight battery cells 200—barrier 100—. . . from the outermost part.

In one embodiment, the plurality of battery cells 200 may be stacked such that the sub-pad 300 is also disposed along with the barrier 100. As a non-limiting example, among the plurality of battery cells 200 stacked in the first direction DR1, they may be stacked and arranged as sub-pad 300—two battery cells 200—sub-pad 300—two battery cells 200—barrier 100— . . . from the outermost part.

In the battery assembly according to one embodiment of the present disclosure, 10% or more, 20% or more, 30% or more, 40% or more, 45% or more, or 50% or less of the total area of the first sub-surfaces 233a of the plurality of stacked battery cells 200 may be additionally protected by the barrier 100.

In the battery assembly according to one embodiment of the present disclosure, 20% or more, 40% or more, 60% or more, 80% or more, or 90% or less of the total area of the second sub-surfaces 233b of the plurality of stacked battery cells 200 may be additionally protected by the barrier 100.

The barrier 100 and the battery assembly 10 according to one embodiment of the present disclosure can be preferably used as a power source for small or medium-to-large devices. Examples of the small devices may include mobile phones, notebook computers, cameras, and the like, and examples of the medium-to-large devices may include electric vehicles, hybrid electric vehicles, plug-in hybrid electric vehicles, and power storage systems, but are not limited thereto.

The above description is merely an example to which the principle of the present disclosure is applied, and other configurations may be further included within the scope not departing from the present disclosure.

What is claimed is:

1. A barrier disposed between at least one pair of adjacent battery cells among a plurality of stacked battery cells, the barrier comprising:
a base portion having a sheet shape; and
a first cover portion and a second cover portion respectively extending from at least one side of the base portion;
wherein an extension length of the first cover portion is shorter than an extension length of the second cover portion.

2. The barrier according to claim 1, wherein the base portion, the first cover portion, and the second cover portion each independently comprise at least one of a fiber or an inorganic material.

3. The barrier according to claim 1, wherein a thickness of the first cover portion is greater than a thickness of the second cover portion.

4. The barrier according to claim 1, wherein the extension length of the first cover portion is 0.4 to 0.6 times the extension length of the second cover portion.

5. The barrier according to claim 1, wherein the base portion comprises a reinforcement member.

6. The barrier according to claim 1, wherein the barrier suppresses propagation of heat or flame.

7. A battery assembly comprising:
a plurality of battery cells stacked in a first direction;
a barrier disposed between at least one pair of adjacent battery cells among the plurality of battery cells; and
a receiving case configured to accommodate the plurality of battery cells and the barrier,
wherein the barrier comprises:
a base portion having a sheet shape;
a first cover portion and a second cover portion respectively extending from at least one side of the base portion along the first direction.

8. The battery assembly according to claim 7, wherein each of the plurality of battery cells comprises:
an electrode assembly;
an electrode terminal electrically connected to the electrode assembly and protruding in a second direction intersecting the first direction; and
a cell case configured to accommodate the electrode assembly, the cell case comprising a first sub-surface and a second sub-surface configured to cover the electrode assembly from a third direction orthogonal to both the first direction and the second direction, and a folding portion formed in at least a portion of the first sub-surface,
wherein the barrier is disposed such that the base portion covers the battery cell in the first direction, the first cover portion covers at least a portion of the first sub-surface, and the second cover portion covers at least a portion of the second sub-surface.

9. The battery assembly according to claim 7, wherein the first cover portion and the second cover portion each have a sheet shape.

10. The battery assembly according to claim 7, wherein the base portion is connected respectively to central portions of the first cover portion and the second cover portion.

11. The battery assembly according to claim 7, wherein the base portion, the first cover portion, and the second cover portion each independently comprise at least one of a fiber or an inorganic material.

12. The battery assembly according to claim 7, wherein a thickness of the base portion is from 1 mm to 5 mm.

13. The battery assembly according to claim 7, wherein a thickness of the first cover portion is greater than a thickness of the second cover portion.

14. The battery assembly according to claim 7, wherein an extension length of the first cover portion is shorter than an extension length of the second cover portion.

15. The battery assembly according to claim 14, wherein the extension length of the first cover portion is 0.4 to 0.6 times the extension length of the second cover portion.

16. The battery assembly according to claim 8, wherein the battery assembly satisfies a relation defined by the following Equation 1:
$$0.8 \leq \frac{{L}_{1} - {W}_{b}}{{W}_{c}} \leq 1.1 \qquad [ Equation 1 ]$$
where L₁ is an extension length of the first cover portion, W_{b} is a thickness of the base portion, and W_{c} is a thickness of the battery cell.

17. The battery assembly according to claim 8, wherein the battery assembly satisfies a relation defined by the following Equation 2:
$$1.8 \leq \frac{{L}_{2} - {W}_{b}}{{W}_{c}} \leq 2.1 \qquad [ Equation 2 ]$$
where L₂ is an extension length of the second cover portion, W_{b} is a thickness of the base portion, and W_{c} is a thickness of the battery cell.

18. The battery assembly according to claim 8, wherein a pair of battery cells disposed adjacent to the barrier have folding directions of the folding portions that are different from each other.

19. The battery assembly according to claim 7, wherein the base portion comprises a reinforcement member.

20. The battery assembly according to claim 7, wherein the barrier suppresses propagation of heat or flame.
